(19) United States
(12) Patent Application Publication
(10) Pub. No.: US 2011/0004369 A1
(43) Pub. Date: Jan. 6, 2011

(54) Method and System for Generating Electronic Documentation for Maintenance

(75) Inventors: François Fournier, Ville (FR); Christian Sannino, Toulouse (FR); Nicolas Rossi, Toulouse (FR)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: THALES, Neuilly-sur-Seine (FR)

(21) Appl. No.: 12/831,112

(22) Filed: Jul. 6, 2010

(30) Foreign Application Priority Data
Jul. 3, 2009 (FR) 09 03286

(51) Int. Cl. G06F 19/00

(52) U.S. Cl. 701/33

(57) ABSTRACT

A method for generating electronic documentation (DOC) for the maintenance of a set of equipment (EQPT), in particular of an aircraft, is provided. The method is beneficial in allowing the automatic generation of electronic documentation (DOC) updated dynamically in tandem with the progress in a maintenance operation on the set of equipment (EQPT). Utilization of particular schemes for constructing dynamic models (ABS) associated with sets of equipment (EQPT) is advantageously accomplished.

### CROSS-REFERENCE TO RELATED APPLICATIONS

This application claims priority to foreign Patent Application FR 09 032 86, filed on Jul. 3, 2009, the disclosure of which is incorporated herein by reference in its entirety.

### FIELD OF THE INVENTION

The present invention relates to the maintenance sector, in particular to aeronautical maintenance. More precisely, the invention consists of a method allowing the automatic generation of electronic documentation for aircraft maintenance. Within the framework of the invention, the electronic documentation generated can evolve dynamically.

### BACKGROUND OF THE INVENTION

Currently, the ground maintenance of an aircraft comprises various steps, comprising firstly the filling in by the onboard personnel of a flight register, or “Logbook” as it is known in the art, listing all the alarms, anomalies, or other events noted by the crew during the flight. All recent aircraft furthermore comprise a piece of equipment called BITE, for “Built-In Test Equipment”, the function of which is to carry out tests on the onboard equipment for the purposes of diagnosis and storage of the events and alarms that have occurred during the flight. After the flight, the aeroplane's centralized maintenance system, of the CFDIU (“Centralized Fault Display Interface Unit”), or CMC (“Centralized Maintenance Computer”) type, generally establishes a flight record, called the PFR for Post Flight Report. Hereinafter, the intervention of the maintenance personnel is based on the consideration of the “Logbook”, of the tests carried out by the BITE function, of the PFR, and optionally of other elements related to the general state of the aircraft, such as deduced from the status of the onboard sensors, accessible by way of reports of the ACMS (“Aircraft Condition & Monitoring System”) type.

The events mentioned in the “Logbook” and the PFR may demand maintenance operations. After having consulted the document which affords an inventory of the necessary and sufficient equipment with a view to performing a flight, which document is known by the term MEL standing for “Minimum Equipment List”, the maintenance personnel can deduce the need or otherwise to perform maintenance operations in the immediate future.

If diagnostics actions have to be conducted, the latter are summarized in a manual often called the FIM for “Fault Isolation Manual” or TSM for “Troubleshooting Manual”. Various documentary sources, generally scattered, and several levels of documents detailing the procedures and the various individual tasks to be conducted, are then at the disposal of the maintenance personnel. The procedures are detailed in documentation known by the term AMM standing for “Aircraft Maintenance Manual”.

When maintenance operations have to be performed, “Jobcards” are printed: they comprise all the tasks that a given maintenance operator has to accomplish. “Checklists” are also formulated: they comprise a list of actions or checks allowing the maintenance operator to be certain that his tasks are performed correctly. Finally, the maintenance operator, after having carried out his job, is generally required to fill in a “Workreport”, which corresponds to a sheet summarizing all the tasks actually performed by the operator.

The current documentation system described above is no longer tailored to the constraints related to the maintenance of recent aircraft. Thus, the drawbacks encountered in the prior art are multifold.

Firstly, in the prior art maintenance procedures, it is considered that the set of messages of events is known exhaustively and that all the associated detailed procedures are at one's disposal. The maintenance operator is responsible for making the link between the documentation at his disposal and the configuration of the equipment on which he is working on the one hand, and the diagnosis corresponding to the messages on the other hand. Now, in the current systems, notably aircraft, the complexity is such that it has become almost impossible to know all the alarm messages which may occur.

Thereafter, the events are processed independently of one another; it is up to the operator to evaluate any links between various events.

### SUMMARY OF THE INVENTION

Embodiments of the present invention advantageously alleviate these drawbacks. One aspect of the present invention generates electronic documentation intended for the maintenance of equipment sets, and in particular of aircraft. The electronic documentation is generated automatically and is updated dynamically, in tandem with the progress in the maintenance operation.

One embodiment of the present invention provides a method for generating electronic documentation for the maintenance of a set of equipment, in particular of an aircraft, the equipment set exhibiting an event, the subject of a maintenance operation, comprising the following steps:
a first step of formulating a model of the set of equipment on the basis of a library of objects representing the equipment and of configuration files,
a second step of generating electronic maintenance documentation for the set of equipment on the basis of a library of maintenance documentary fragments, the maintenance documentary fragments, selected to form part of the electronic maintenance documentation, being chosen as a function of the model established in the first step, and of the operating state of the set of equipment.

The method according to the invention exhibits a location algorithm making it possible to determine a list of possible origins for the event, the subject of the maintenance operation, the list of possible origins for the event being taken into account in the formulation of the electronic maintenance documentation.

Advantageously, the electronic maintenance documentation can be formulated as a function of a maintenance strategy aimed at ordering the list of possible origins for the event according to inherent criteria.

Preferably, the list of possible origins for the event is ordered in order of probability, in order of intervention time, or in order of cost of intervention.

Advantageously, the method according to an embodiment of the present invention can comprise a step of formatting the electronic maintenance documentation as a function of a library imposing formatting criteria.

Advantageously, the method according to an embodiment of the present invention comprises means for dynamically altering the electronic maintenance documentation as a function of the results of tests carried out on the set of equipment.

In a preferred embodiment of the invention, the first step of formulating the model of the set of equipment comprises at least one step of constructing the model of the set of equipment on the basis of a library of objects comprising the pieces of equipment of the set of equipment, the model of the set of equipment furthermore comprising the operating state of each of the pieces of equipment, and any event relating to the maintenance of the pieces of equipment.

Advantageously, the method according to an embodiment of the present invention comprises means for ascertaining the operating state of the set of equipment.

Advantageously, the analysis of at least one of the following documents makes it possible to ascertain the operating state of the set of equipment: a logbook and a flight record.

Advantageously, the electronic maintenance documentation comprises a set of procedures for analyzing anomalies and diagnosis.

Advantageously, the electronic maintenance documentation comprises a set of maintenance procedures tailored to the set of equipment.

Advantageously, the electronic maintenance documentation comprises an intervention card intended for a maintenance operator having to perform a maintenance operation on the set of equipment.

Advantageously, the electronic maintenance documentation comprises a checklist intended for a maintenance operator having to perform a maintenance operation on the set of equipment.

Advantageously, the electronic maintenance documentation comprises a minimum list of equipment that has to be functioning to allow operation of the set of equipment.

Advantageously, a system for aiding the maintenance of a set of equipment of an aircraft can comprise means for implementing the method described above.

### BRIEF DESCRIPTION OF THE DRAWINGS

Other characteristics and advantages of the present invention will become apparent with the aid of the description which follows given with regard to the appended drawings which represent:

FIG. 1 depicts a schematic representation of an embodiment of the present invention; and

FIGS. 2a, 2b, 2c depict diagrams representing various embodiments of the present invention.

### DETAILED DESCRIPTION

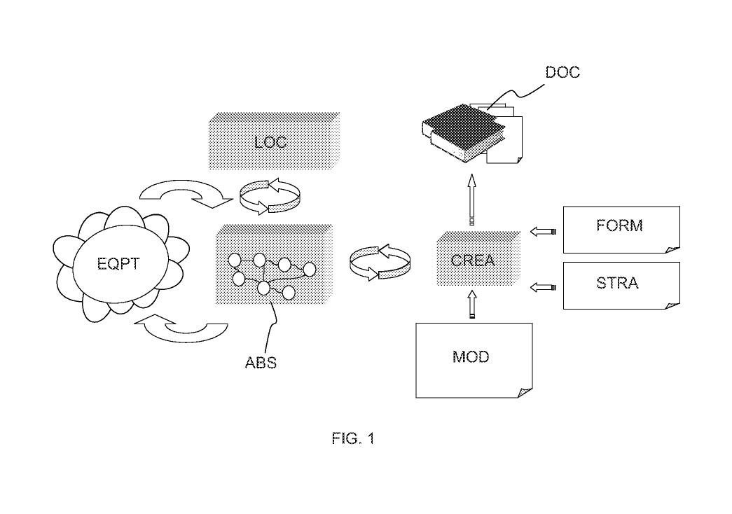

FIG. 1 presents a diagram illustrating the operating principle of the invention. The first step consists in constructing a model ABS corresponding to the set of equipment EQPT, typically an aircraft, on which a maintenance operation is conducted. The model ABS allows the consideration of the topology and of the configuration of the set of equipment EQPT. To construct this model ABS, it is possible to apply the method described in patent application FR0704012 or any other equivalent method.

The method according to the invention consists in utilizing the model ABS of the set of equipment EQPT to be maintained, the model ABS comprising the exact configuration of the set of equipment EQPT, with a view to constructing the documentation DOC tailored to the requirement, within the framework of the envisaged maintenance operation.

During the step of constructing the model ABS of the set of equipment EQPT, exchanges aimed at resolving the doubts on the state of the set of equipment EQPT, with a view to confirming for example, certain faults, are performed between the model ABS and the set of equipment EQPT.

The step of constructing the model ABS and of confirming the operating state of the set of equipment EQPT is succeeded by a location step LOC for pinpointing the faults or, generally, the events that have occurred, with the aid of an algorithm or of any known method.

Starting from the model ABS of the set of equipment EQPT, and knowing the events to be analyzed and their location on the set of equipment EQPT, the central element of the method according to the invention is the creation CREA of the dynamic electronic documentation DOC. A system allowing the implementation of the method according to the invention therefore comprises an electronic documentation creator CREA. The electronic documentation DOC is associated with the maintenance operation envisaged for the set of equipment EQPT. It exhibits the advantage of being dynamically alterable. The model ABS and the electronic documentation DOC indeed evolve dynamically. Thus, the operator follows in a sequential manner a list of tasks: the result of a test conducted by the operator on the set of equipment EQPT can alter the list of tasks remaining to be performed. To generate the electronic documentation DOC, the documentation creator CREA consults a library MOD comprising modules constituting documentary fragments. The fragments relevant within the framework of the envisaged maintenance operation are chosen and make it possible to create the complete electronic documentation DOC. The method according to the invention can in this step be based on the S1000D standard. The S1000D standard is an international specification relating to the provision and production of technical publications. From version 2 thereof, it applies to the civilian and military sectors and to aeronautical, terrestrial and maritime equipment. This S1000D standard fixes formats for constructing and utilizing MOD libraries consisting of documentary fragments intended for the maintenance of equipment sets.

Moreover, to construct the electronic documentation DOC that is tailored in the best possible manner to the maintenance operation envisaged, the documentation creator CREA can also consult a maintenance strategy STRA. Such a maintenance strategy STRA, developed by the manufacturer or by the operator of the set of equipment EQPT, consists of fault analysis schemes related to the experience or the knowledge of the systems: for example, this can involve, within the framework of a fault which may originate from two different pieces of equipment, checking the operation of one of the pieces of equipment before the other, for practical or economic reasons, or for reasons to do with the probability of malfunction. The strategy STRA also consists in allowing the results of the actions already performed to be taken into consideration with a view to updating the electronic maintenance documentation DOC.

To summarize, the method according to the invention relies mainly on combining the implementation of patent application FR0704012 with the application of the S1000D standard.

Within the framework of a preferred mode of implementation of the invention, the step of creating the electronic documentation also comprises the consultation of standards, such as the S1000D standard, or of any library FORM imposing criteria for formatting the electronic documentation DOC: organization into paragraphs, indentation, character fonts . . . etc.

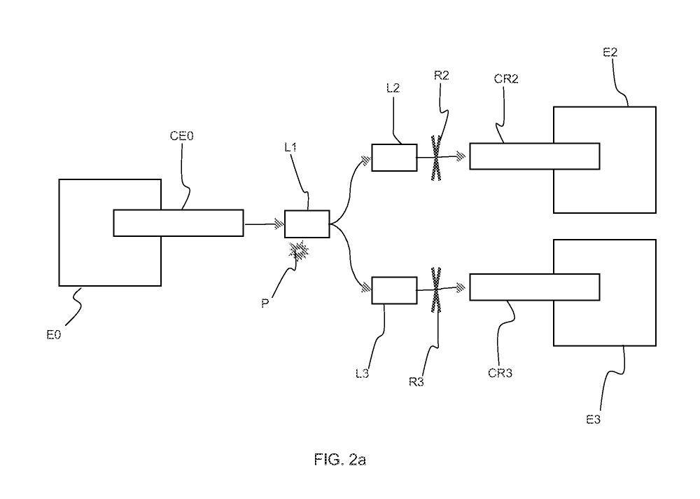

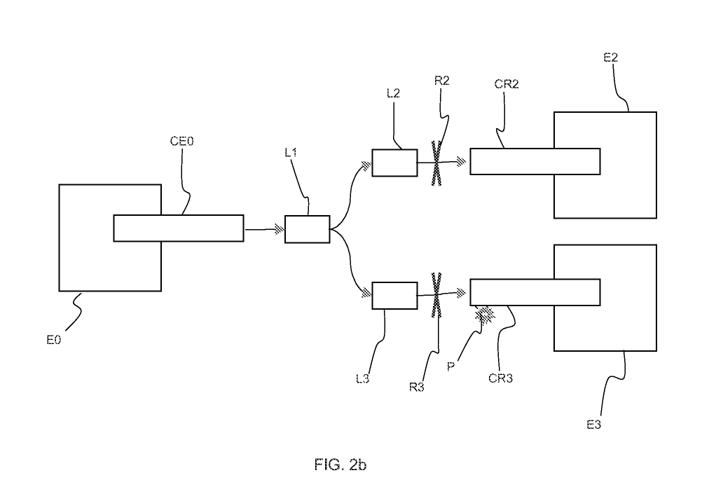

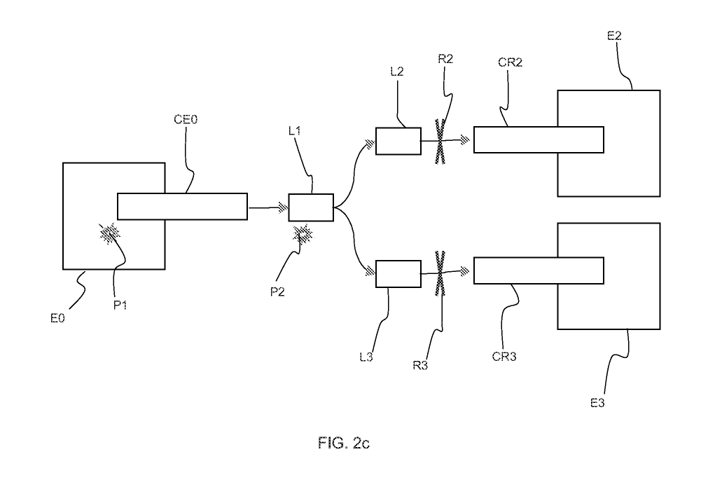

FIGS. 2a, 2b, 2c illustrate examples of particular cases and of the implementation of the method according to the invention. These examples should not of course be considered to be exhaustive.

The particular feature of the three cases of faults presented here is that the algorithm or the method LOC for locating the fault is apt to give the same result in each of these cases. This result consists of a list of equipment E1, E2, E3, links L1, L2, L3, connectors CE0, CR2, CR3 . . . etc., elements of the set of equipment EQPT considered, the elements being ordered according to criteria specific to the algorithm or to the fault location method LOC. The elements pertinent to the fault can be ranked from the most probable to the least probable; for example:
the most probable is that the equipment E1 is faulty,
a fault with the link L1 is 50 times less probable than a fault with the equipment E1,
a fault with the link L2 is 500 times less probable than a fault with the equipment E1,
fault with the link L3 is 500 times less probable than a fault with the equipment E1,
fault with the receive connector CR2 of the equipment E2 is 500 times less probable than a fault with the equipment E1,
a fault with the receive connector CR3 of the equipment E3 is 500 times less probable than a fault with the equipment E1,
a fault with the send connector CE0 of the equipment E1 is 500 times less probable than a fault with the equipment E1,
. . . etc.

Other faults may have yet lower probabilities, for example 25000 times lower than the probability of a fault with the equipment E1.

The model ABS determined in FIG. 1 and the fault location algorithm or method LOC allow definite identification of the equipment implicated E1, E2, E3 as well as the communication links L1, L2, L3 and the connectors potentially affected CE0, CR2, CR3.

The documentary fragments associated with the equipment E1, E2, E3, with the links L1, L2, L3 as well as with the connectors CE0, CR2, CR3 emanate from the library MOD described in FIG. 1.

In the example envisaged, the strategy STRA for formulating the electronic documentation DOC could be:
on request of the operator, initialize a “Jobcard”, a “Checklist” and a “Workreport”,
compile the procedures associated with possible faults such as determined by the location algorithm or method LOC, from the most probable to the least probable,
display only one procedure at a time to the operator, test after test, task after task,
complete the associated “Jobcard”, “Checklist” and “Workreport” in tandem,
if the problem is not corrected, the strategy STRA consists in taking into consideration the result of the tests and tasks performed and generating the procedure for the next potentially implicated element; this step can be repeated for as long as the fault is not corrected,
when the problem is corrected, finalize the “Jobcard”, the “Checklist” and the

“Workreport” as a function of the tasks actually performed by the operator, and pass to the following operation if there is one, according to the same operational mode.

By applying the procedure according to the invention with the strategy STRA such as described above in the case of FIG. 2a, the following result is obtained. The electronic documentation creator CREA will:
display the “Jobcard”,
display the “Checklist” related to the diagnostics actions which are described in the FIM or TSM manual and which are themselves related to the procedures described in the AMM manual,
initialize the “Workreport”,
display the procedures:
   the FIM firstly displays the procedure aimed at confirming whether or not the equipment E1 is faulty,
   the FIM makes the operator perform a test on the equipment E1 and refers to the associated procedure in the AMM,
   the procedure described in the AMM may allow the operator to run the test directly, for example via the BITE function of the equipment E1,
   in the example of FIG. 2a, the test shows that the equipment E1 is not faulty,
   the FIM takes into account the result of the test and displays the procedure aimed at confirming whether or not the link L1 is faulty,
   the FIM makes the operator perform a test on the link L1 and refers to the associated procedure in the AMM,
   the operator then notes a problem on the link L1 and confirms the problem in the FIM,
   the FIM concludes and makes the link with the associated procedures in the AMM so as to repair/change/reinstate the link L1,
rerun the location algorithm or method LOC and retrieve the new results; in the example, it is noted that the problem is corrected; there is no fault message,
finalize the “Jobcard”, the “Checklist” and the “Workreport”
process other faults, if any.

By applying the procedure according to the invention with the strategy STRA such as described above in the case of FIG. 2b, the following result is obtained. The electronic documentation creator CREA will, according to the invention:
display the “Jobcard”,
display the “Checklist” related to the diagnostics actions which are described in the FIM or TSM manual and which are themselves related to the procedures described in the AMM manual,
initialize the “Workreport”,
display the procedures:
   the FIM firstly displays the procedure aimed at confirming whether or not the equipment E1 is faulty,
   the FIM makes the operator perform a test on the equipment E1 and refers to the associated procedure in the AMM,
   the procedure described in the AMM may allow the operator to run the test directly, for example via the BITE function of the equipment E1,
   in the example of FIG. 2a, the test shows that the equipment E1 is not faulty,
   the FIM takes into account the result of the test and displays the procedure aimed at confirming whether or not the link L1 is faulty,
   the FIM makes the operator perform a test on the link L1 and refers to the associated procedure in the AMM,
   the operator does not note any problem on the link L1,
   the FIM takes into account the result of the test and displays the procedure aimed at confirming whether or not the link L2 is faulty,
   the FIM makes the operator perform a test on the link L2 and refers to the associated procedure in the AMM,
   the operator does not note any problem on the link L2,
   the FIM takes into account the result of the test and displays the procedure aimed at confirming whether or not the link L3 is faulty,
   the FIM makes the operator perform a test on the link L3 and refers to the associated procedure in the AMM,
   the operator does not note any problem on the link L3,
   the FIM takes into account the result of the test and displays the procedure aimed at confirming whether or not the receive connector CR2 of the equipment E2 is faulty,
   the FIM makes the operator perform a test on the receive connector CR2 and refers to the associated procedure in the AMM,
   the operator does not note any problem on the receive connector CR2,
   the FIM takes into account the result of the test and displays the procedure aimed at confirming whether or not the receive connector CR3 of the equipment E3 is faulty,
   the FIM makes the operator perform a test on the receive connector CR3 and refers to the associated procedure in the AMM,
   the operator then notes a problem on the receive connector CR3 and confirms the problem in the FIM,
   the FIM concludes and makes the link with the associated procedures in the AMM so as to repair/change/reinstate the receive connector CR3,
rerun the location algorithm or method LOC and retrieve the new results; in the example, it is noted that the problem is corrected; there is no fault message,
finalize the “Jobcard”, the “Checklist” and the “Workreport”
process other faults, if any.

By applying the procedure according to the invention with the strategy STRA such as described above in the case of FIG. 2c, the following result is obtained. The electronic documentation creator CREA will, according to the invention:
display the “Jobcard”,
display the “Checklist” related to the diagnostics actions which are described in the FIM or TSM manual and which are themselves related to the procedures described in the AMM manual,
initialize the “Workreport”,
display the procedures:
   the FIM firstly displays the procedure aimed at confirming whether or not the equipment E1 is faulty,
   the FIM makes the operator perform a test on the equipment E1 and refers to the associated procedure in the AMM,
   the procedure described in the AMM may allow the operator to run the test directly, for example via the BITE function of the equipment E1,
   in the example of FIG. 2c, the test shows that the equipment E1 is faulty,
   the FIM concludes and makes the link with the associated procedures in the AMM so as to repair/change/reinstate the equipment E1,
rerun the location algorithm or method LOC and retrieve the new results; in the example, it should be noted that the problem is not corrected; a cycle of tasks to be performed by the operator is therefore rerun:
   the FIM displays the procedure aimed at confirming whether or not the link L1 is faulty,
   the FIM makes the operator perform a test on the link L1 and refers to the associated procedure in the AMM,
   the operator then notes a problem on the link L1 and confirms the problem in the FIM,
   the FIM concludes and makes the link with the associated procedures in the AMM so as to repair/change/reinstate the link L1,
rerun the location algorithm or method LOC and retrieve the new results; in the example, it is noted that the problem is corrected; there is no fault message,
finalize the “Jobcard”, the “Checklist” and the “Workreport”
continue the maintenance operation by passing to the following subjects.

At the end of the operations, the “Jobcard” and “Workreport” documents can obviously be archived or transmitted to the operator of the set of equipment.

When the set of equipment evolves, in terms of hardware or configuration, the model ABS also evolves; so that the method according to the invention is efficacious, it then suffices to update the documentary fragments of the library MOD.

It should be pointed out that the examples of generated documentations, as well as their captions, are not exhaustive in the present disclosure. The present method is applicable in respect of any type of documentation within the framework of maintenance operations for a set of equipment EQPT, in particular in the aeronautical sector.

Finally, the present document covers not only the method for dynamically generating electronic documentation DOC for maintenance but also the system comprising means tailored to implement it, the means comprising in particular a generator of the model ABS of the set of equipment EQPT and an electronic documentation creator CREA.

The many features and advantages of the invention are apparent from the detailed specification, and, thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and, accordingly, all suitable modifications and equivalents may be resorted to that fall within the scope of the invention.

What is claimed is:

1. A method for generating electronic documentation for the maintenance of a set of equipment for an aircraft, the equipment set exhibiting an event that is the subject of a maintenance operation, the method comprising:
formulating a model of the set of equipment on the basis of a library of objects representing equipment and configuration files; and
generating an electronic maintenance documentation of the set of equipment on the basis of a library of maintenance documentary fragments, the maintenance documentary fragments, selected to form part of the electronic maintenance documentation, being chosen as a function of the model and the operating state of the set of equipment.

2. The method according to claim 1, wherein a location algorithm makes it possible to determine a list of possible origins for the event, the subject of the maintenance operation, the list of possible origins for the event being taken into account in the formulation of the electronic maintenance documentation.

3. The method according to claim 1, wherein the electronic maintenance documentation is further formulated as a function of a maintenance strategy aimed at ordering the list of possible origins for the event according to inherent criteria.

4. The method according to claim 3, wherein the list of possible origins for the event is ordered in order of probability, intervention time, or cost of intervention.

5. The method according to claim 1, further comprising formatting the electronic maintenance documentation as a function of a library imposing formatting criteria.

6. The method according to claim 1, further comprising dynamically altering the complete maintenance documentation as a function of the results of tests carried out on the set of equipment.

7. The method according to claim 1, wherein said formulating the model of the set of equipment comprises at least constructing the model of the set of equipment on the basis of a library of objects comprising the pieces of equipment of the set of equipment, the model of the set of equipment including the operating state of each of the pieces of equipment, and any event relating to the maintenance of the pieces of equipment.

8. The method according to claim 1, further comprising ascertaining the operating state of the set of equipment.

9. The method according to claim 8, wherein the analysis of at least one of the following documents makes it possible to ascertain the operating state of the set of equipment: a logbook and a flight record.

10. The method according to claim 1, wherein said electronic maintenance documentation comprises a set of procedures for analyzing anomalies and diagnosis.

11. The method according to claim 1, wherein said electronic maintenance documentation comprises a set of maintenance procedures tailored to the set of equipment.

12. The method according to claim 1, wherein said electronic maintenance documentation comprises an intervention card intended for a maintenance operator having to perform a maintenance operation on the set of equipment.

13. The method according to claim 1, wherein said electronic maintenance documentation comprises a check-list intended for a maintenance operator having to perform a maintenance operation on the set of equipment.

14. The method according to claim 1, wherein said electronic maintenance documentation comprises a minimum list of equipment that has to be functioning to allow operation of the set of equipment.
